(19) United States
(12) Patent Application Publication
(10) Pub. No.: US 2021/0016676 A1
(43) Pub. Date: Jan. 21, 2021

(54) DUAL-POWER-SUPPLY DUAL-MODE PURE ELECTRIC PASSENGER VEHICLE

(71) Applicants: Hanping YI, Tianjin (CN); Siqi ZHOU, Beijing (CN)

(72) Inventors: Hanping YI, Tianjin (CN); Siqi ZHOU, Beijing (CN); Hu ZHOU, Beijing (CN)

(73) Assignees: Hanping YI, Tianjin (CN); Siqi ZHOU, Beijing (CN)

(21) Appl. No.: 17/042,930

(22) PCT Filed: Jun. 14, 2018
(86) PCT No.: PCT/CN2018/091277

§ 371 Date: Sep. 29, 2020

(30) Foreign Application Priority Data
May 16, 2018 (CN) 201810464498.5

(51) Int. Cl. B60L 53/80; H02J 9/06; B60L 50/50; H01M 10/44

(52) U.S. Cl. CPC B60L 53/80; H01M 10/44; B60L 50/50; H02J 9/061

(57) ABSTRACT

A dual-power-supply dual-mode pure electric passenger vehicle includes two power batteries: One is used as a standby power battery and adopts a charging mode; and the other is a power battery that can be loaded and removed at any time and adopts a battery swap mode. Both power batteries can be powered separately. Under normal circumstances, the power battery for battery swap is preferably adopted. The power battery for the battery swap is connected to the vehicle through a connector, the connector includes a high-voltage electrical interface, a low-voltage electrical interface and a communication interface. When the power of the power battery for the battery swap is used up, the charged power battery is used.

### CROSS REFERENCE TO THE RELATED APPLICATIONS

This application is the national phase entry of International Application No. PCT/CN2018/091277, filed on Jun. 14, 2018, which is based upon and claims priority to Chinese Patent Application No. 201810464498.5, filed on May 16, 2018, the entire contents of which are incorporated herein by reference.

### TECHNICAL FIELD

The present application relates to a new-energy vehicle, particularly to a pure electric new-energy passenger vehicle.

### BACKGROUND

A new-energy vehicle is the development direction of the automobile industry. Chinese governments vigorously develop the new-energy vehicle. There are mainly three types of the new-energy vehicles. The first one is a hybrid electric new-energy vehicle. The second one is a pure electric new-energy vehicle, and the third one is a fuel cell new-energy vehicles. China mainly supports and develops the pure electric new-energy vehicles. There are mainly two modes for a pure electric new-energy passenger vehicle: One is a charging mode, and the other is a battery swap mode. The pure electric new-energy passenger vehicle in the charging mode is a mainstream. Currently, the pure electric new-energy passenger vehicle in the charging mode mainly has the problems of insufficient continuous travel mileage and too long charging time. The continuous travel mileage of the pure electric new-energy passenger vehicle can be increased by increasing the capacity of a battery. However, if the capacity of the equipped battery is too large, the self-weight, energy consumption, cost, and charging time of the battery are increased. A vast majority of people's daily mileage is less than 150 kilometers, and occasionally a longer mileage is required. It is not cost-effective for the pure electric new-energy passenger vehicle to install a large-capacity battery. The battery swap mode can solve the problem of too long charging time, but a battery swap process is more complicated. The battery swap mode has relatively large infrastructure investment, and the cost of each battery swap is higher than that of charging.

### SUMMARY

The objective of the present application is to provide a pure electric new-energy passenger vehicle that not only meets the requirement for a daily low cost but also meets the requirement for an occasional long-distance driving mileage. In order to meet the requirement for the daily low cost of use, the pure electric new-energy passenger vehicle is equipped with a power battery with relatively small capacity, and adopts a charging mode. In order to meet requirement for the occasional long-distance driving mileage, the pure electric new-energy passenger vehicle uses a battery swap mode, which can replenish energy in a short time. In order to meet the above requirements at the same time, the present application adopts a dual-power-supply dual-mode mode, that is, the pure electric new-energy passenger vehicle has two power batteries: One is a standby power battery, which can meet the daily use and adopts the charging mode; and the other is a power battery that can be loaded and removed at any time and adopts the battery swap mode, which can meet the requirements for the occasional long-distance driving mileage. Both power batteries can be powered separately. Under normal circumstances, the power battery for battery swap is preferably adopted to supply electricity. When the power of the power battery for the battery swap is used up, the power of the standby power battery is used. The dual-power-supply dual-mode pure electric passenger vehicle, like an ordinary pure electric passenger vehicle, mainly consists of a vehicle body, a chassis, an electrical device. A power system of the pure electric passenger vehicle also mainly consists of a motor, an electronic control, and the battery. The difference is the power battery. The ordinary pure electric passenger vehicle generally has only one power battery, which can be charged or replaced. The dual-power-supply dual-mode pure electric passenger vehicle has two power batteries: One is used for charging the vehicle and the other is used for the battery swap.

### BRIEF DESCRIPTION OF THE DRAWINGS

FIG. 1 is a schematic diagram of the connection of a power battery of a pure electric passenger vehicle in a charging mode, wherein 11 is an on-board charging interface; 12 is a power battery, and 13 is an electrical system.

FIG. 2 is a schematic diagram of the charging of a power battery of a pure electric passenger vehicle in a charging mode, wherein 11 is an on-board charging interface; 12 is a power battery; 13 is an electrical system, and the arrow represents the flowing direction of electric energy.

FIG. 3 is a schematic diagram of the discharging of a power battery of a pure electric passenger vehicle in a charging mode, wherein 11 is an on-board charging interface; 12 is a power battery; 13 is an electrical system, and the arrow represents the flowing direction of electric energy.

FIG. 4 is a schematic diagram of the connection of a power battery of a pure electric passenger vehicle in a battery swap mode, wherein 21 is a battery swap interface; 22 is a power battery, and 23 is an electrical system.

FIG. 5 is a schematic diagram of the discharging of a power battery of a pure electric passenger vehicle in a battery swap mode, wherein 21 is a power swap interface; 22 is a power battery; 23 is an electrical system, and the arrow represents the flowing direction of electric energy.

FIG. 6 is a schematic diagram of the charging of a power battery of a pure electric passenger vehicle in a battery swap mode, wherein 21 is a power swap interface; 22 is a power battery; 24 is a charging device outside the vehicle, and the arrow represents the flowing direction of electric energy.

FIG. 7 is a schematic diagram of the connection of a power battery of a pure electric passenger vehicle in a dual-power-supply dual-mode mode, wherein 31 is an on-board charging interface; 32 is a standby power battery; 33 is an electrical system; 34 is a power battery for battery swap, and 35 is a battery swap interface.

FIG. 8 is a schematic diagram of the connection of a pure electric passenger vehicle in a dual-power-supply dual-mode mode only equipped with a standby power battery, wherein 31 is an on-board charging interface; 32 is a standby power battery; 33 is an electrical system, and 35 is a battery swap interface.

FIG. 9 is a schematic diagram of the discharging of a power battery of a pure electric passenger vehicle in dual-power-supply dual-mode mode, wherein 31 is an on-board charging interface; 32 is a standby power battery; 33 is an electrical system; 34 is a power battery for battery swap; 35 is a battery swap interface, and the arrow represents the flowing direction of electrical energy.

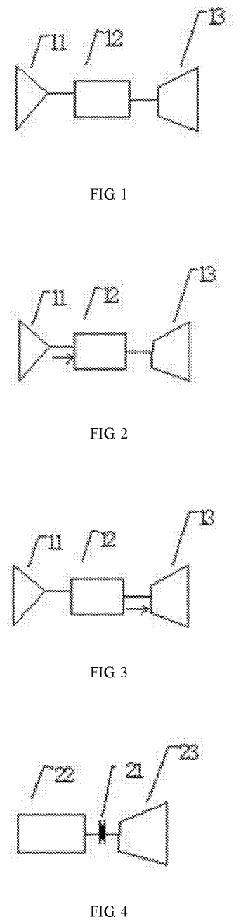

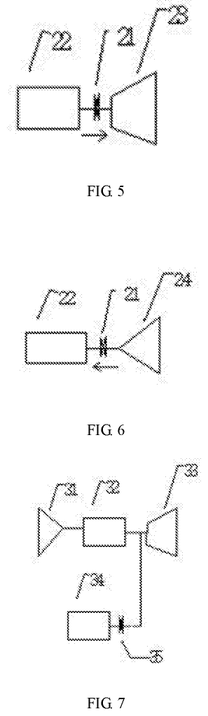

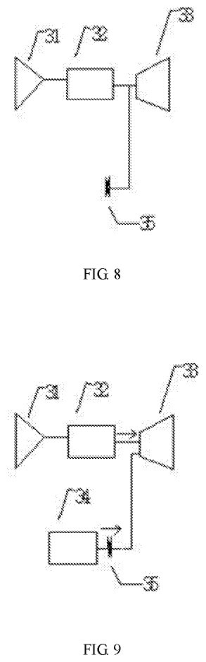

### DETAILED DESCRIPTION OF THE EMBODIMENTS

### Embodiment 1

A dual-power-supply dual-mode pure electric passenger vehicle mainly consists of a vehicle body, a chassis, and an electrical device. A power system of the chassis mainly consists of a motor, an electric control, and a battery. The dual-power-supply dual-mode pure electric passenger vehicle has two power batteries: One is a standby power battery, which adopts a charging mode; and the other is a power battery that can be loaded and removed at any time and adopts a battery swap mode. Both power batteries can be powered separately. Under normal circumstances, the power battery for battery swap is preferably adopted. When the power of the power battery for the battery swap is used up, the power of a charged power battery is used. The standby power battery is installed under the chassis, and the power battery for the battery swap is installed in a front compartment. The power battery for the battery swap is connected to the vehicle via a connector. The connector comprises a high-voltage electrical interface, a low-voltage electrical interface, and a communication interface.

### Embodiment 2

The dual-power-supply dual-mode pure electric passenger vehicle mainly consists of a vehicle body, a chassis, and an electrical device. A power system of the chassis mainly consists of a motor, an electric control, and a battery. The dual-power-supply dual-mode pure electric passenger vehicle has two power batteries: One is a standby power battery, which adopts a charging mode; and the other is a power battery that can be loaded and removed at any time and adopts a battery swap mode. Both power batteries can be powered separately. Under normal circumstances, the power battery for battery swap is preferably adopted. When the power of the power battery for the battery swap is used up, the power of a charged power battery is used. The standby power battery is installed under the chassis, and the power battery for the battery swap is installed in a rear luggage compartment. The power battery for the battery swap is connected to the vehicle through a connector. The connector comprises a high-voltage electrical interface, a low-voltage electrical interface, and a communication interface.

What is claimed is:

1. A dual-power-supply dual-mode pure electric passenger vehicle, comprising:
two power batteries; wherein a first power battery of the two power batteries is a standby power battery in a charging mode, and a second power battery of the two power batteries is a power battery for battery swap in a battery swap mode;
the two power batteries are powered separately;
under normal circumstances, the power battery for the battery swap supplies electricity; and
the power battery for the battery swap is connected to the dual-power-supply dual-mode pure electric passenger vehicle through a connector, and the connector comprises a high-voltage electrical interface, a low-voltage electrical interface and a communication interface.

2. The dual-power-supply dual-mode pure electric passenger vehicle according to claim 1, wherein
the standby power battery is installed under a chassis, and the power battery for the battery swap is installed in a rear luggage compartment.
